(19) United States
(12) Patent Application Publication
(10) Pub. No.: US 2011/0220161 A1
(43) Pub. Date: Sep. 15, 2011

(54) Independently Adjusting, Multi-Legged Walking Cane

(76) Inventors: James D. Jordan, (US); Randy G. Misenheimer, (US); Shyh Min Chen, Plano, TX (US)

(21) Appl. No.: 12/723,224

(22) Filed: Mar. 12, 2010

(51) Int. Cl. A45B 3/04; A45B 9/04; A61H 3/00

(52) U.S. Cl. 135/66; 135/82

(57) ABSTRACT

The invention is a multi-legged walking cane where each leg operates independently of each other by employing compressible legs, enhancing stability thru the complete gait cycle.

### CROSS-REFERENCE TO RELATED APPLICATIONS

None

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Not Applicable

### BACKGROUND OF THE INVENTION

(1) Field of the Invention

The present invention pertains to canes used by those who need assistance in maintaining stability while walking.

(2) Description of the Related Art including Information Disclosed under 37 CFR 1.97 and 1.98

Walking canes are well known to those with ordinary skill in the art. Walking canes from prior art include the ancient walking cane consisting of a single stick held in one hand and providing stability when the user places the distal end on the ground in the direction of travel so that the stick provides a third point of contact with the ground as the user moves. Modern walking canes can be more complex, with three or four legs on a foot assembly (U.S. Pat. No. 4,044,784), allow for an adjustment of staff length (U.S. Pat. No. 4,085,763), or telescoping canes for easy storage when not in use (U.S. Pat. No. 3,987,807).

Newer multiple-leg canes attempt to provide superior stabilization by providing more than one point of contact with the ground. With two or more contacts, the cane is less likely to twist or turn than when a single point of contact is maintained. However, the success of these canes is limited because the points of contact must change during the gait.

For example, a four-legged cane usually has only two of its legs in contact with the ground for most of a user's gait; the back two legs of a four-legged cane touch the ground when the user extends it out to take a step. As the user's center of gravity reaches the cane's contact points, all four legs are on the ground, and then as the user passes the contact points and before the user pulls up the cane and places it forward again, only the front two legs of the cane remain in contact with the ground. This creates a multiple-stage use of the cane that is less graceful than the use of a standard one-legged cane.

Another challenge for multiple-legged canes comes when the ground upon which the user is walking is uneven. If a user is walking on unimproved dirt or rock, a multi-leg cane may have only two or three legs touching the ground. Under such circumstances the user can be surprised by the lack of contact of one leg that creates in an unexpected lack of support and result with the user falling.

Existing canes are bulky, not easily dissembled, and require the same amount of space whether they are in use or not.

What is needed is a multi-legged cane that can, a) maintain multiple points of contact during the entirety of the user's gait, b) easily self-adjust to changing ground surfaces, and c) can be easily dissembled when not in use.

### BRIEF SUMMARY OF THE INVENTION

The general object of the multi-legged cane is to offer those needing assistance to walk with a cane that provide the increased stability of a multi-legged cane with the ability to adjust to rough ground, as well as to provide a graceful motion of the cane throughout a user's gate. The invention uses independently adjustable and tensioned legs on the cane to gain these advantages.

The cane also can be easily dissembled and reassembled by use of a single nut which holds the multiple legs at the lower end of the threaded cane.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations pointed out in the appended claims.

### BRIEF DESCRIPTION OF THE SEVERAL VIEWS OF THE DRAWING

The attached drawings are provided as non-limiting examples of the invention:

FIG. 1—Orthogonal view of the cane.

FIG. 2a—Orthogonal view of a three-legged leg base.

FIG. 2b—Orthogonal view of a four-legged leg base.

FIG. 3—Section view of the cane's lower end with optional locking end cap.

FIG. 3a—Side view of the optional locking end cap.

FIG. 3b—Orthogonal view of the cane's lower end, showing leg slots.

FIG. 3c—Top view of a leg.

FIG. 4—Orthogonal partial view of cane's base.

### DETAILED DESCRIPTION OF THE INVENTION

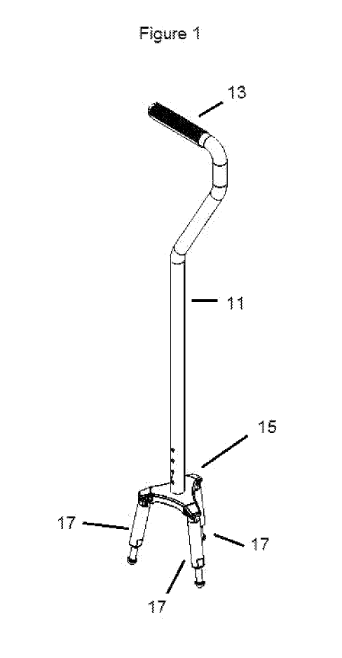

According to the present invention, the foregoing and other objects and advantages are attained by a cane as in FIG. 1, comprising a shaft 11, said shaft with upper end with handle element 13, lower end with base 15 holding multiple legs 17, each with an independently operating spring system 19.

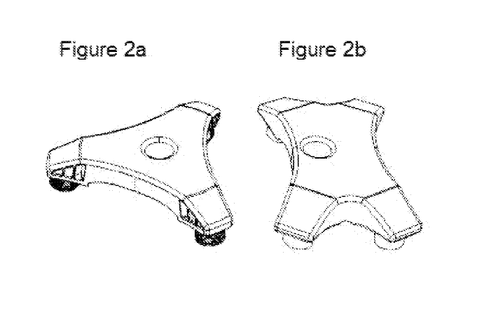

The base 15 can be fixed to the cane's lower end by threads, screws or other means. Different bases can be interchanged onto the cane to allow for different numbers of legs, typically two to four on a base. FIG. 2 shows bases for two- and three-legged bases.

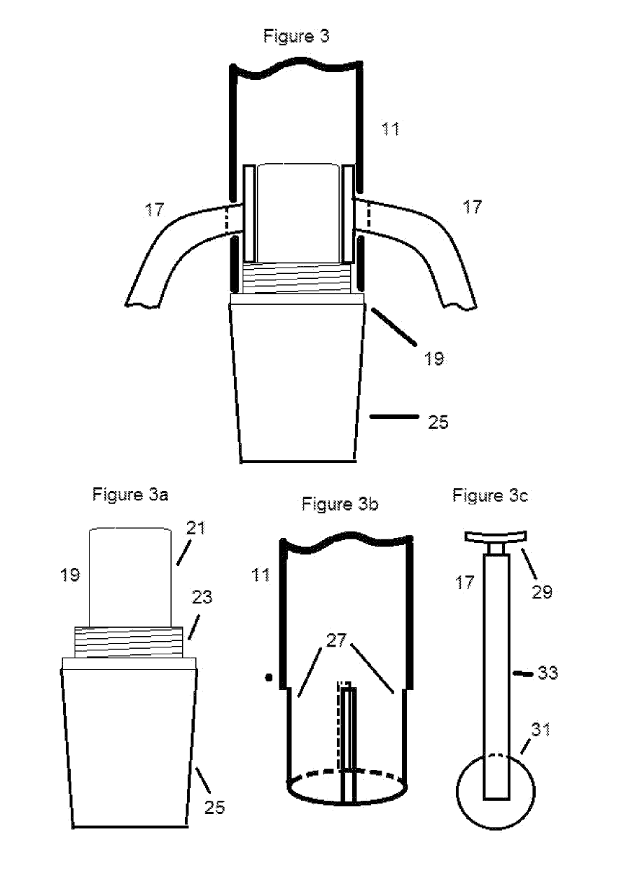

As an alternative to a base into which the legs are affixed, the lower end of the cane can be slotted and threaded, so each leg slides into a slot and is held in place with a locking cap 19 which screws into the lower end of the cane, as shown in FIG. 3. FIG. 3a shows a locking cap 19, comprising a threaded section 23 to hold the cap on the cane, an interior section used to hold the legs in place 21, and an optional elongated section 25 operating as a leg that may or may not have a compressible element on its end. The threaded lower end of a four-legged cane is presented in FIG. 3b, showing the slots 27 where the legs are held to the cane. FIG. 3c shows a top view of a typical leg 17, comprising an assembly element 29, and a foot element 31 that makes contact with the walking surface.

To replace a leg, the user slides the leg 17 up into the slot 27, positions it, and then screws the locking cap 19 into the cane's end. The locking cap 19 has an upper portion 21 that fills the bulk of the interior space of the cane, and assists in holding the assembly element (typically a back plate) 29 in place when the locking cap is screwed into the cane.

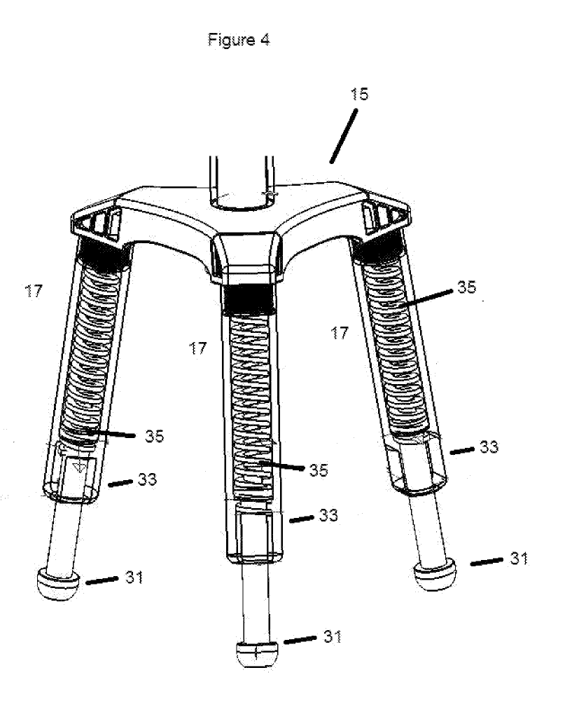

As shown in FIG. 4, each leg 17 consists of a tube section 33, a spring or tension element 35, and a foot 31 to provide solid contact with the walking surface. The flange slides into the slots of the primary shaft 13. In the preferred embodiment, each leg 17 contains a spring positioned between the plunger at its lower end, and an end stop at its upper end. The position of the spring's end stop is adjustable by use of detents in each leg (not shown), allowing for each user of the cane to adjust for his preferences and needs.

Other embodiments use compressed air or tensioned rubber products to allow for the compression. In the preferred embodiment, the cane has three legs, but other embodiments could have fewer or more. In all cases, the cane's user would place his weight on the cane, and the cane would respond by allowing some compression in cane legs equipped with compression elements such that the user's weight is distributed on the several legs, irrespective of uneven ground.

Another optional construction is to have a middle leg that does not compress. On the cane construction using a locking end cap in FIG. 3, a lower section 25 is used as the primary leg, operating as a more typical one-legged cane does as an extension of the cane's shaft.

There are many possible combinations, such as a cane the center leg rigid, but other legs compressible. In unusual cases, one or more of the other legs would be rigid, with others compressible, depending on a user's rehabilitative needs.

As the user walks, the cane's angle with the ground changes. The legs will decompress and compress as the user walks, just as he would with a single-legged cane, but with the added assistance of the other legs' contact with the ground, the cane is less likely to twist or slip.

1) A walking cane, comprising a near end and distal end, said distal end constructed with multiple legs, in which one or more of the legs have a means of compression.

2) Apparatus as in claim 1, in which the compressible legs are removable from the distal end;

3) Apparatus as in claim 1, in which the compressible legs have a means of adjusting the tension of the springs;

4) Apparatus as in claim 1, in which one or more of the legs are held in place with a single threaded end bolt that threads into the end of the cane, and removing the bolt allows the legs to slide off of the end;

5) Apparatus as in claim 4, in which the bolt which threads into the cane has an extended head with sufficient length to act as a cane leg.

6) Apparatus as in claim 1, in which the base has one central leg that does not compress.

7) Apparatus as in claim 1, in which the means of compression is a spring inside the tube of each compressible leg;

8) Apparatus as in claim 1, in which the means of compression is compressed gas.

9) Apparatus as in claim 1, in which the means of compression is a strained elastomeric material.

10) Apparatus as in claim 1, in which an alarm siren is added internally to the cane, and activated by a switch on or near the cane's handle.

11) Apparatus as in claim 1, in which the cane is equipped with a battery-powered LED that is fixed to or near the base of the cane to illuminate the path of the user.
